(19) United States
(12) Patent Application Publication
(10) Pub. No.: US 2023/0418173 A1
(43) Pub. Date: Dec. 28, 2023

(54) TONER

(71) Applicant: CANON KABUSHIKI KAISHA, Tokyo (JP)

(72) Inventors: TAKASHI MATSUI, Shizuoka (JP); KENJI AOKI, Shizuoka (JP); YUHEI TERUI, Shizuoka (JP); MARIKO YAMASHITA, Shizuoka (JP)

(21) Appl. No.: 18/339,873

(22) Filed: Jun. 22, 2023

(30) Foreign Application Priority Data
Jun. 22, 2022 (JP) 2022-100653

(51) Int. Cl. G03G 9/08; G03G 9/087

(52) U.S. Cl. CPC G03G 9/0821; G03G 9/08711

(57) ABSTRACT

A toner comprising a toner particle, the toner particle comprises a binder resin. The binder resin comprises an amorphous resin A and a crystalline resin C. T1, T2 and T3 satisfy specific relationships, where, in a viscoelasticity measurement of the toner, T1 (° C.) represents a temperature at which a storage elastic modulus G′ is 3.0×10⁷ Pa, T2 (° C.) represents temperature at which the storage elastic modulus G′ is 1.0×10⁷ Pa, and T3 (° C.) represents a temperature at which the storage elastic modulus G′ is 3.0×10⁶ Pa. A storage elastic modulus G′ (100) at 100° C. is in a specific range. In an observation of a cross section of the toner, a matrix-domain structure having a matrix by the crystalline resin C and domains by the amorphous resin A is observed, an area ratio and a number-basis average surface area of the domains are in specific ranges.

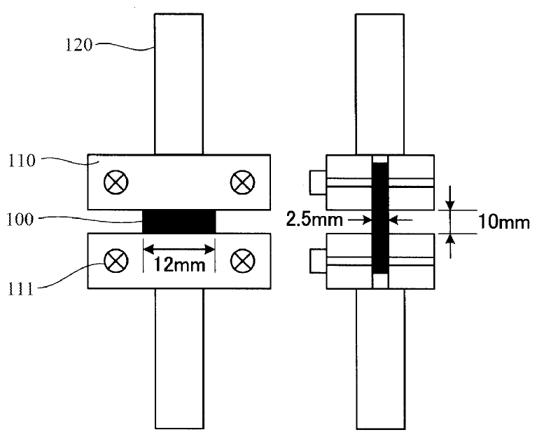

### BACKGROUND OF THE INVENTION

### Field of the Invention

The present disclosure relates to a toner that is used in electrophotography and electrostatic recording methods.

### Description of the Related Art

Conventionally, energy saving in electrophotography apparatuses is considered to be a big technical issue, and a significant reduction in the amount of heat applied to fixing apparatuses has been considered. In particular, there are growing needs for so-called “low-temperature fixability” of toners, which enables fixation of the toners with lower energy.

As a technique for enabling fixation of a toner at low temperatures, for example, WO 2013/047296 discloses a toner to which a plasticizer is added. The plasticizer has a function of increasing the softening rate of a binder resin while maintaining the glass transition temperature (Tg) of the toner, and can improve the low-temperature fixability. However, the toner softens through a step of plasticizing the binder resin after the plasticizer is melted, and accordingly, there is a limit in the melting rate of the toner, and a further improvement in the low-temperature fixability is desired.

Under the above circumstances, consideration has been given to a method of using a crystalline resin as the binder resin. Amorphous resins that are commonly used as binder resins for a toner do not have clear endothermic peaks in differential scanning calorimetry (DSC), but in the case where a crystalline resin component is contained, an endothermic peak (melting point) appears in differential scanning calorimetry.

Crystalline resins have a characteristic of hardly softening at temperatures lower than the melting point due to regular arrangement of molecular chains. Also, crystals of crystalline resins rapidly melt when the temperature exceeds the melting point, and the viscosity rapidly decreases as the crystals melt. Therefore, crystalline resins have excellent sharp melt properties and are attracting attention as materials that have the low-temperature fixability. Japanese Patent Application Publication No. 2014-142632 proposes a toner having a toner particle that contains a binder resin and a colorant, wherein the binder resin contains an amorphous resin A and a crystalline resin C, the melting point Tm (C) of the crystalline resin C is from 50° C. to 110° C., a cross-sectional observation of the toner particle reveals a sea-island structure made up of a sea portion having the crystalline resin C as a main component and island portions having the amorphous resin A as a main component.

The toner disclosed in Japanese Patent Application Publication No. 2014-142632 can be fixed at low energy and can form an image that is resistant to external forces such as rubbing and scratching. However, it has been found that it is difficult for the toner to satisfy low-temperature fixability and heat-resistant storability, combined with hot offset resistance, in particular in high-speed machines. The toner has also proven to be disadvantageous in terms of stackability (characteristic pertaining to adhesion between paper sheets and that occurs when printed paper sheets are piled on top of each other while still warm) in high-speed machines.

### SUMMARY OF THE INVENTION

The present disclosure provides a toner that satisfies low-temperature fixability and heat-resistant storability in high-speed machines, while also exhibiting excellent hot offset resistance and stackability.

The present disclosure relates to a toner comprising a toner particle, the toner particle comprising a binder resin, wherein the binder resin comprises an amorphous resin A and a crystalline resin C; T1, T2 and T3 satisfy expressions (1) and (2):

T3−T1≤10.0 (1)

50.0≤T2≤70.0 (2)

Where, in a viscoelasticity measurement of the toner, T1 (° C.) represents a temperature at which a storage elastic modulus G′ is 3.0×10⁷ Pa, T2 (° C.) represents temperature at which the storage elastic modulus G′ is 1.0×10⁷ Pa, and T3 (° C.) represents a temperature at which the storage elastic modulus G′ is 3.0×10⁶ Pa; in the viscoelasticity measurement of the toner, a storage elastic modulus G′ (100) at 100° C. is 1.0×10⁴ to 1.0×10⁶ Pa; and in an observation of a cross section of the toner using a scanning transmission electron microscope, a matrix-domain structure having a matrix by the crystalline resin C and domains by the amorphous resin A is observed in the cross section, an area ratio of the domains in the cross section of the toner is 45 to 95 area %, and a number-basis average surface area of the domains in the cross section of the toner is 100 to 100,000 nm².

The present disclosure provides a toner that satisfies low-temperature fixability and heat-resistant storability in high-speed machines, while also exhibiting excellent hot offset resistance and stackability.

Further features of the present disclosure will become apparent from the following description of exemplary embodiments.

### BRIEF DESCRIPTION OF THE DRAWINGS

The Figure is an example of sample mounting in a viscoelasticity measurement.

### DESCRIPTION OF THE EMBODIMENTS

In the present disclosure, the wordings “from XX to YY” and “XX to YY” expressing numerical value ranges mean numerical value ranges including the lower limit and the upper limit as endpoints, unless otherwise stated. When numerical value ranges are described stepwise, upper limits and lower limits of those numerical value ranges can be combined suitably. The term “(meth)acrylic acid ester” means an acrylic acid ester and/or a methacrylic acid ester.

The term “monomer unit” refers to a reacted form of a monomer material included in a polymer. For example, a section including a carbon-carbon bond in a main chain of a polymer formed through polymerization of a vinyl monomer will be referred to as a single unit. A vinyl monomer can be represented by the following formula (C).

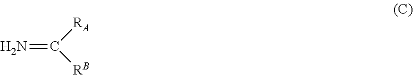

In the formula (C), RA represents a hydrogen atom or an alkyl group (preferably, an alkyl group having 1 to 3 carbon atoms, and more preferably a methyl group), and R B represents any substituent. The term “crystalline resin” refers to a resin that has a clear endothermic peak in differential scanning calorimetry (DSC).

The inventors found that the above disadvantage can be solved by properly controlling the storage elastic modulus G′ in a viscoelasticity measurement of the toner, and by controlling a matrix-domain structure having a matrix by the crystalline resin C and domains by the amorphous resin A at the time of an observation of a cross section of the toner. The present disclosure relates to a toner comprising a toner particle, the toner particle comprising a binder resin, wherein the binder resin comprises an amorphous resin A and a crystalline resin C; T1, T2 and T3 satisfy following expressions (1) and (2):

T3−T1≤10.0 (1)

50.0≤T2≤70.0 (2)

Where, in a viscoelasticity measurement of the toner, T1 (° C.) represents a temperature at which a storage elastic modulus G′ is 3.0×10⁷ Pa, T2 (° C.) represents temperature at which the storage elastic modulus G′ is 1.0×10⁷ Pa, and T3 (° C.) represents a temperature at which the storage elastic modulus G′ is 3.0×10⁶ Pa; in the viscoelasticity measurement of the toner, a storage elastic modulus G′ (100) at 100° C. is 1.0×10⁴ to 1.0×10⁶ Pa; and in an observation of a cross section of the toner using a scanning transmission electron microscope, a matrix-domain structure having a matrix by the crystalline resin C and domains by the amorphous resin A is observed in the cross section, an area ratio of the domains in the cross section of the toner is 45 to 95 area %, and a number-basis average surface area of the domains in the cross section of the toner is 100 to 100,000 nm².

In order to realize both the low-temperature fixability and the heat-resistant storability, the storage elastic modulus needs to be high until the temperature of the toner reaches a temperature that is determined as a requirement for the heat-resistant storability and the storage elastic modulus needs to rapidly decrease when the temperature of the toner becomes higher than that temperature, or in other words, the toner needs to have sharp melt properties (the expressions (1) and (2)).

Also, hot offset resistance can be achieved by controlling the storage elastic modulus at high temperature.

In order to control these characteristics it is important to control properly a matrix-domain structure (sea-island structure) having a matrix (sea portion) by the crystalline resin C and domains (island portions) by the amorphous resin A, at the time of an observation of a toner cross section; this allows further improving stackability.

The following describes the toner in detail. In measurement of viscoelasticity of the toner, a temperature at which the storage elastic modulus G′ is 3.0×10⁷ Pa will be denoted by T1(° C.), a temperature at which the storage elastic modulus G′ is 1.0×10⁷ Pa will be denoted by T2(° C.), and a temperature at which the storage elastic modulus G′ is 3.0×10⁶ Pa will be denoted by T3(° C.). At this time, T1, T2, and T3 satisfy the following expressions (1) and (2).

T3−T1≤10.0 (1)

50.0≤T2≤70.0 (2)

Low-temperature fixability, stackability and heat-resistant storability of toner in a high-speed machine can all be achieved by satisfying expression (1) and expression (2). When T3-T1 is larger than 10.0° C., low-temperature fixability and stackability in a high-speed machine are poorer.

Preferably, T3-T1 is 8.0° C. or less, and more preferably 7.0° C. or less. The lower limit of T3-T1 is not particularly restricted, but is preferably 1.0° C. or larger, 3.0° C. or larger or 5.0° C. or larger. Preferably, T3-T1 is from 1.0 to 8.0° C., or from 3.0 to 8.0° C., or from 5.0 to 8.0° C., or from 3.0 to 7.0° C., or from 5.0 to 7.0° C.

Herein T3-T1 can be controlled for instance on the basis of the proportion of the crystalline resin C in the toner, the proportion of segments exhibiting crystallinity in the crystalline resin C, the shape of the domains in the matrix-domain structure, the ratio of matrix and domains, and the compositions of the matrix and the domains.

Further, T1 is preferably from 46.0 to 65.0° C., and more preferably from 52.0 to 56.0° C.

In turn, T3 is preferably from 54.0 to 71.0° C., and more preferably from 58.0 to 62.0° C.

When T2 is lower than 50.0° C., low-temperature fixability is advantageous, but the stackability and the heat-resistant storability of the toner are impaired. When by contrast T2 is higher than 70.0° C., the toner exhibits excellent performance in terms of heat-resistant storability, but with poorer low-temperature fixability. Further, T2 is preferably from 55.0 to 65.0° C., more preferably from 56.0 to 60.0° C., and yet more preferably from 57.0 to 59.0° C.

In a case where the crystalline resin C in the toner is a vinyl resin having a long-chain alkyl group, T2 can be controlled for instance on the basis of the length of the long-chain alkyl group and the proportion of the long-chain alkyl group in the crystalline resin. In a case where the crystalline resin C is a polyester resin, T2 can be controlled on the basis of the number of carbon atoms in the diol component and in the dicarboxylic acid component that are used.

In a viscoelasticity measurement of the toner, the storage elastic modulus G′ (100) at 100° C. is from 1.0×10⁴ to 1.0×10⁶ Pa. Hot offset resistance drops when the storage elastic modulus G′ (100) is smaller than 1.0×10⁴ Pa. Also low-temperature fixability decreases when the storage elastic modulus G′ (100) at 100° C. is larger than 1.0×10⁶ Pa.

The storage elastic modulus G′ (100) at 100° C. can be controlled for instance on the basis of the shape of the domains in the matrix-domain structure, the ratio of the matrix and the domains, the compositions of the matrix and the domains, and through cross-linking.

The storage elastic modulus G′ (100) is preferably from 4.0×10⁴ to 6.0×10⁵ Pa, and more preferably from 8.0×10⁴ to 3.0×10⁵ Pa.

In an observation of a toner cross section using a scanning transmission electron microscope, the matrix-domain structure (sea-island structure) having a matrix (sea portion) of the crystalline resin C and domains (island portions) of the amorphous resin A is observed in the cross section. The domains and matrix may have dispersed therein, as needed, additional materials such as a colorant.

The area ratio of the domains in the toner cross section is from 45 to 95 area %, and the number-basis average surface area of the domains is from 100 to 100,000 nm²

When the crystalline resin C is present in the matrix and the amorphous resin A is present in the domains, a sharp melt property and the shape after fixing are readily maintained, so that low-temperature fixability and stackability in a high-speed machine are satisfied as a result.

That is because when the matrix is the crystalline resin C, the influence of the matrix can be made more pronounced at the time of fixing, and thus a sharp melt property can be brought out. When the amorphous resin A is present in the domains, the shape after fixing is readily maintained, and as a result stackability is satisfied.

When the matrix is the amorphous resin A and the domains are the crystalline resin C, the sharp melt property decreases and the shape after fixing is harder to maintain, and accordingly low-temperature fixability and stackability in a high-speed machine can no longer be satisfied.

The matrix-domain structure can be controlled for instance on the basis of the compatibility between the crystalline resin C and the amorphous resin A, the quantity ratio of the crystalline resin C and the amorphous resin A, and the conditions for generating the amorphous resin A (polymerization rate and temperature conditions). For instance even if the amount of the crystalline resin C is smaller than that of the amorphous resin A, the polymerization rate can be increased and the average surface area of the islands can be controlled to be smaller, so that a matrix by the crystalline resin C can be formed as a result, by controlling the compatibility of the crystalline resin C and the amorphous resin A, and controlling the monomer units and generation conditions (polymerization rate and temperature condition) of the amorphous resin A.

When the area ratio of the domains in the cross section is lower than 45 area %, the domains cannot come into contact with each other at the time of fixing, and elasticity is likely to drop, which translates into poorer hot offset resistance and stackability. When the area ratio of the domains in the cross section is higher than 95 area %, the ratio of the matrix becomes relatively lower which entails a poorer sharp melt property and lower low-temperature fixability at the time of fixing.

The area ratio of the domains in a toner cross section can be controlled for instance on the basis of the compatibility between the crystalline resin C and the amorphous resin A, the quantity ratio of the crystalline resin C and the amorphous resin A, and the generation conditions of the amorphous resin A (polymerization rate, temperature conditions).

The area ratio of the domains in the cross section is preferably from 60 to 90 area %, more preferably from 70 to 90 area %, and yet more preferably from 70 to 80 area %.

When the number-basis average surface area of the domains is smaller than 100 nm 2, elasticity readily drops at the time of fixing, and stackability decreases.

When the number-basis average surface area of the domains is larger than 100,000 nm² the domains cannot come into contact with each other, and elasticity drops readily at the time of fixing. Hot offset resistance and stackability decrease as a result.

The number-basis average surface area of the domains can be controlled for instance on the basis of the compatibility between the crystalline resin C and the amorphous resin A, the quantity ratio of the crystalline resin C and the amorphous resin A, and the generation conditions of the amorphous resin A (polymerization rate and temperature conditions).

The average surface area of the domains is preferably from 100 to 10,000 nm², more preferably from 200 to 3,000 nm², and yet more preferably from 250 to 500 nm².

The toner has a toner particle containing a binder resin. The binder resin contains the crystalline resin C.

Examples of the crystalline resin C include vinyl resins, polyester resins, polyurethane resins and epoxy resins having crystallinity, preferably vinyl resins having crystallinity.

In a case where the crystalline resin C is a vinyl resin having crystallinity, the crystalline resin C preferably has monomer unit (a) represented by Formula (3) below.

In Formula (3), R⁴ represents a hydrogen atom or a methyl group, and n represents an integer from 15 to 35.

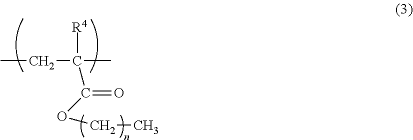

By having thus the monomer unit (a) represented by Formula (3), the crystalline resin C can readily form a side-chain crystalline structure, and as a result a sharp melt property and fast crystallization can both be achieved, and also low-temperature fixability at high-speed fixing and stackability can be more readily improved.

When n in Formula (3) is 15 or larger, the melting point tends to be higher, and heat-resistant storability and stackability are readily improved.

When n in Formula (3) is 35 or smaller, crystallinity increases, and the sharp melt property and stackability are readily improved. Preferably, n in Formula (3) is from 17 to 29, and more preferably from 19 to 23.

As a method for introducing the monomer unit (a), it is possible to use a method of polymerizing any of the following (meth)acrylic acid esters. Examples of the (meth)acrylic acid esters include (meth)acrylic acid esters that have a linear alkyl group having 16 to 36 carbon atoms [stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, etc.] and (meth)acrylic acid esters that have a branched alkyl group having 18 to 36 carbon atoms [e.g., 2-decyltetradecyl (meth)acrylate]. One type of monomer may be used alone or two or more types of monomers may be used in combination to form the monomer unit (a).

In the case where the crystalline resin C is a crystalline vinyl resin, the crystalline resin C can include another monomer unit in addition to the monomer unit (a). As a method for introducing the other monomer unit, it is possible to use a method of polymerizing any of the (meth)acrylic acid esters listed above and another vinyl monomer.

Examples of the other vinyl monomer include the followings.

(Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate.

Monomers that have a urea group, such as monomers obtained by causing a reaction between an amine having 3 to 22 carbon atoms [e.g., a primary amine (normal-butylamine, t-butylamine, propylamine, isopropylamine, etc.), a secondary amine (di-normal-ethylamine, di-normal-propylamine, di-normal-butylamine, etc.), aniline, cycloxyl amine, etc.] and an isocyanate that has an ethylenically unsaturated bond and 2 to 30 carbon atoms, by using a known method.

Monomers that have a carboxy group, such as methacrylic acid, acrylic acid, and 2-carboxyethyl (meth)acrylate.

Monomers that have a hydroxy group, such as 2-hydroxyethyl (meth)acrylate and 2-hydroxypropyl (meth)acrylate.

Monomers that have an amide group, such as acrylamides and monomers obtained by causing a reaction between an amine having 1 to 30 carbon atoms and a carboxylic acid (acrylic acid, methacrylic acid, etc.) that has an ethylenically unsaturated bond and 2 to 30 carbon atoms, by using a known method.

In particular, styrene, methacrylic acid, acrylic acid, methyl (meth)acrylate, and t-butyl (meth)acrylate are preferably used.

The content ratio of the monomer unit (a) represented by Formula (3) in the crystalline resin C is preferably from 50.0 to 100.0 mass %.

When the content ratio is 50.0 mass % or higher, the melting point is prone to be high, and heat-resistant storability, low-temperature fixability and stackability are yet more readily improved. The lower limit is more preferably 60.0 mass % or higher, yet more preferably 65.0 mass % or higher, and even yet more preferably 70.0 mass % or higher. The upper limit is more preferably 95.0 mass % or lower, yet more preferably 90.0 mass % or lower, and even yet more preferably 85.0 mass % or lower. For instance, the content ratio is preferably from 60.0 to 95.0 mass %, or from 65.0 to 90.0 mass %, or from 70.0 to 85.0 mass %.

In a case where two or more types of monomer units (a) are present in the crystalline resin C, the content ratio of the monomer unit (a) is the total sum of the foregoing.

The crystalline resin C preferably has styrene-derived monomer unit represented by Formula (A) below. The crystalline resin C preferably has monomer unit derived from a (meth)acrylic acid represented by Formula (B) below.

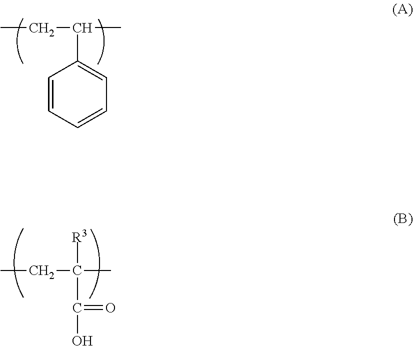

In Formula (B), R³ represents a hydrogen atom or a methyl group. Further, R³ is preferably a methyl group.

The content ratio of the monomer unit derived from styrene in the crystalline resin C is preferably from 1.0 to 50.0 mass %, more preferably from 10.0 to 30.0 mass %, and yet more preferably from 15.0 to 25.0 mass %.

The content ratio of the monomer unit derived from a (meth)acrylic acid (preferably methacrylic acid) in the crystalline resin C is preferably from 0.5 to 5.0 mass %, more preferably from 1.0 to 3.0 mass %, and yet more preferably from 1.5 to 2.5 mass %.

In a case where the crystalline resin C is a polyester resin, a resin exhibiting crystallinity can be used from among polyester resins that can be obtained as a result of a reaction between a divalent or higher polyvalent carboxylic acid and a polyvalent alcohol.

Examples of the carboxylic acid having two or more carboxy groups include the following compounds. Dibasic acids such as succinic acid, adipic acid, sebacic acid, phthalic acid, isophthalic acid, terephthalic acid, malonic acid, and dodecenyl succinic acid, anhydrides and lower alkyl esters of these, and aliphatic unsaturated dicarboxylic acids such as maleic acid, fumaric acid, itaconic acid, and citraconic acid.

Examples of the carboxylic acid having two or more carboxy groups also include 1,2,4-benzenetricarboxylic acid, 1,2,5-benzenetricarboxylic acid, and anhydrides and lower alkyl esters of these. These may be used alone or in combination of two or more.

Examples of the polyhydric alcohol include the following compounds. Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. Alkyl moieties in alkylene glycols and alkylene ether glycols may be linear or branched.

Examples of the polyhydric alcohol further include glycerol, trimethylolethane, trimethylolpropane, and pentaerythritol. These may be used alone or in combination of two or more.

It is also possible to use a monovalent acid such as acetic acid or benzoic acid or a monohydric alcohol such as cyclohexanol or benzyl alcohol to adjust the acid value or the hydroxyl value. Although there is no particular limitation on the method for manufacturing the polyester resin, the polyester resin can be manufactured using either a transesterification method or a direct polycondensation method or a combination of these methods.

The content ratio of the crystalline resin C in the toner is preferably from 10.0 to 60.0 mass %. Within the above range, crystallization of the toner is further promoted, and both a sharp melt property and fast crystallization can be achieved more fully, and low-temperature fixability at high-speed fixing and stackability can be further improved.

The lower limit of the content ratio of the crystalline resin C is more preferably 15.0 mass % or higher, yet more preferably 20.0 mass % or higher, even yet more preferably 25.0 mass % or higher, and particularly preferably 30.0 mass % or higher. The upper limit is more preferably 55.0 mass % or lower, yet more preferably 50.0 mass % or lower, even yet more preferably 40.0 mass % or lower, and particularly preferably 35.0 mass % or lower.

For instance, the content ratio of the crystalline resin C is preferably from content 15.0 to 55.0 mass %, or from 20.0 to 50.0 mass %, or from 25.0 to 40.0 mass %, or from 30.0 to 35.0 mass %.

The binder resin contains the amorphous resin A in addition to the crystalline resin C. Examples of the amorphous resin A include vinyl resins, polyester resins, polyurethane resins and epoxy resins, preferably vinyl resins and polyester resins.

More preferably, the amorphous resin A is a vinyl resin. The amorphous resin A preferably has monomer unit (b) represented by Formula (4) below.

In Formula (4), R¹ represents a hydrogen atom or a methyl group, and R⁵ represents a C1 to C4 alkyl group (preferably a methyl group or a t-butyl group).

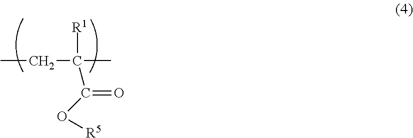

The surface area of the domains can readily be made smaller thanks to the presence of the monomer unit (b) represented by Formula (4). Therefore, the contact area between the domains can be improved at the time of fixing, and stackability can be improved more readily.

The monomers that form the monomer unit (b) may be used singly or in combinations of two or more types.

In a case where the amorphous resin A is a vinyl resin, the method for introducing the monomer unit (b) may be a method that involves polymerizing a vinylic monomer that allows obtaining a monomer unit (b) structure.

In a case where the amorphous resin A is a vinyl resin, other monomer units may be present in addition to the monomer unit (b). Methods for introducing other monomer units include polymerizing a vinylic monomer that allows forming another monomer unit structure.

Methyl acrylate, methyl methacrylate, t-butyl acrylate and t-butyl methacrylate are preferred as vinylic monomers that allow forming a monomer unit (b) structure.

When these vinylic monomers are selected, the reactivity between the vinylic monomers increases readily, and accordingly the surface area of the domains can be controlled to be small.

The content ratio of the monomer unit (b) in the amorphous resin A is preferably from 5.0 to 60.0 mass %. The lower limit is more preferably 10.0 mass % or higher, yet more preferably 20.0 mass % or higher, even yet more preferably 30.0 mass % or higher, and particularly preferably 35.0 mass % or higher. The upper limit is more preferably 55.0 mass % or lower, yet more preferably 50.0 mass % or lower, even yet more preferably 45.0 mass % or lower, and particularly preferably 40.0 mass % or lower. For instance, the content ratio is preferably from 10.0 to 55.0 mass %, or from to 50.0 mass %, or from 30.0 to 45.0 mass %, or from 35.0 to 40.0 mass %.

In a case where two or more types of monomer units (b) are present in the amorphous resin A, the content ratio of the monomer unit (b) is the sum total thereof. For instance the amorphous resin A preferably has at least one type of monomer unit b1 selected from the group consisting of monomer units in which R⁵ in Formula (4) is a methyl group or a t-butyl group.

The content ratio of the monomer unit b1 in the amorphous resin A is preferably from 25.0 to 50.0 mass %, more preferably from 30.0 to 45.0 mass %, and yet more preferably from 35.0 to 40.0 mass %.

The amorphous resin A may further have monomer unit b2 in which R⁵ in Formula (4) is an n-butyl group. The content ratio of the monomer unit b2 in the amorphous resin A is preferably from 3.0 to 20.0 mass %, and more preferably from 7.0 to 11.0 mass %.

The amorphous resin A preferably has monomer unit (c) represented by Formula (7) below.

In Formula (7), R² represents a hydrogen atom or a methyl group, and m represents an integer from 7 to 35.

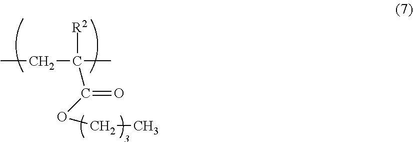

Through the presence of the monomer unit (c), the compatibility of the amorphous resin A with the crystalline resin C and can be controlled, adhesiveness at the interface between the crystalline resin C and the amorphous resin A in the toner is readily improved, and the durability of the toner is yet more readily improved. Tangling of the resin in the matrix can be readily controlled through the presence of the monomer unit (c), so that the storage elastic modulus G′ (100) can be readily increased as a result.

A preferred range of m is herein from 7 to 29, more preferably from 7 to 19, yet more preferably from 7 to 15, even yet more preferably from 7 to 14, especially preferably from 9 to 14, and particularly preferably from 9 to 13.

Methods for introducing the monomer unit (c) include a method that involves polymerizing one or more of the following (meth)acrylic acid esters, in addition to the (meth)acrylic acid ester that can be used in the monomer unit (a). For instance octyl (meth)acrylate, decyl (meth)acrylate, lauryl (meth)acrylate, myristyl (meth)acrylate or palmityl (meth)acrylate.

The monomers that form the monomer unit (c) may be used singly or in combinations of two or more types.

The amorphous resin A can also have other monomer units, in addition to the monomer unit (c). Methods for introducing monomer units include a method that involves polymerizing the above-described (meth) acrylic acid ester and a vinylic monomer that can be used in the crystalline resin C.

For instance the amorphous resin A may contain from 25.0 to 50.0 mass % of styrenic monomer units.

The amorphous resin A may have monomer units formed by a known cross-linking agent, such as hexanediol diacrylate, having a plurality of vinyl groups, acryloyl groups, methacryloyl groups or the like.

The content ratio of the monomer unit (c) in the amorphous resin A is preferably from 5.0 to 40.0 mass %. The lower limit is more preferably 10.0 mass % or higher, and yet more preferably 15.0 mass % or higher. The upper limit is more preferably 35.0 mass % or lower, yet more preferably 30.0 mass % or lower, and even yet more preferably 25.0 mass % or lower.

For instance, the content ratio is preferably from 10.0 to 35.0 mass %, or from 15.0 to 30.0 mass %, or from 15.0 to 25.0 mass %.

In a case where the amorphous resin A is a polyester resin, a resin not exhibiting crystallinity can be used from among polyester resins that can be obtained as a result of a reaction between the divalent or higher polyvalent carboxylic acids and polyvalent alcohols described above.

The content ratio of the amorphous resin A in the binder resin is preferably from 20.0 to 90.0 mass %, more preferably from 50.0 to 80.0 mass %, and yet more preferably from 60.0 to 75.0 mass %.

The weight-average molecular weight (Mw) of a tetrahydrofuran (THF)-soluble fraction of the toner as measured by gel permeation chromatography (GPC) is preferably from 10,000 to 200,000. The lower limit is more preferably 30,000 or higher, and yet more preferably 50,000 or higher. More preferably, the upper limit is 180,000 or lower. The low-temperature fixability and durability of the toner are more readily improved when Mw lies within the above ranges.

The toner may contain a release agent. The release agent is preferably at least one selected from the group consisting of a hydrocarbon wax and an ester wax. Use of a hydrocarbon wax and/or an ester wax makes it easy to achieve effective releasability.

The hydrocarbon wax is not particularly limited, but examples thereof are as follows. Aliphatic hydrocarbon waxes: low molecular weight polyethylene, low molecular weight polypropylene, low molecular weight olefin copolymers, Fischer Tropsch waxes, and waxes obtained by subjecting these to oxidation or acid addition.

The ester wax should have at least one ester bond per molecule, and may be a natural ester wax or a synthetic ester wax. Ester waxes are not particularly limited, but examples thereof are as follows: Esters of a monohydric alcohol and a monocarboxylic acid, such as behenyl behenate, stearyl stearate and palmityl palmitate; Esters of a dicarboxylic acid and a monoalcohol, such as dibehenyl sebacate; Esters of a dihydric alcohol and a monocarboxylic acid, such as ethylene glycol distearate and hexane diol dibehenate; Esters of a trihydric alcohol and a monocarboxylic acid, such as glycerol tribehenate; Esters of a tetrahydric alcohol and a monocarboxylic acid, such as pentaerythritol tetrastearate and pentaerythritol tetrapalmitate; Esters of a hexahydric alcohol and a monocarboxylic acid, such as dipentaerythritol hexastearate, dipentaerythritol hexapalmitate and dipentaerythritol hexabehenate; Esters of a polyfunctional alcohol and a monocarboxylic acid, such as polyglycerol behenate; and natural ester waxes such as carnauba wax and rice wax.

Of these, esters of a hexahydric alcohol and a monocarboxylic acid, such as dipentaerythritol hexastearate, dipentaerythritol hexapalmitate and dipentaerythritol hexabehenate, are preferred.

The release agent may be a hydrocarbon-based wax or an ester wax in isolation, a combination of a hydrocarbon-based wax and an ester wax, or a mixture of two or more types of each, but it is preferable to use a hydrocarbon-based wax in isolation or two or more types thereof. It is more preferable for the release agent to be a hydrocarbon wax.

In the toner, the release agent has a content of preferably from 1.0 mass % to 30.0 mass %, or more preferably from 2.0 mass % to 25.0 mass % in the toner particle. If the content of the release agent in the toner particle is within this range, the release properties are easier to secure during fixing. The melting point of the release agent is preferably from 60° C. to 120° C. If the melting point of the release agent is within this range, it is more easily melted and exuded on the toner particle surface during fixing, and is more likely to provide release effects. The melting point is more preferably from 70° C. to 100° C.

The toner may also contain a colorant. Examples of colorants include known organic pigments, organic dyes, inorganic pigments, and carbon black and magnetic particles as black colorants. Other colorants conventionally used in toners may also be used. Examples of yellow colorants include condensed azo compounds, isoindolinone compounds, anthraquinone compounds, azo metal complexes, methine compounds and allylamide compounds. Specifically, C.I. pigment yellow 12, 13, 14, 15, 17, 62, 74, 83, 93, 94, 95, 109, 110, 111, 128, 129, 147, 155, 168 and 180 can be used by preference.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221 and 254 can be used by preference. Examples of cyan colorants include copper phthalocyanine compounds and their derivatives, anthraquinone compounds, and basic dye lake compounds. Specifically, C.I. pigment blue 1, 7, 15, 15:1, 15:2, 15:3, 60, 62 and 66 can be used by preference.

The colorants are selected based on considerations of hue angle, chroma, lightness, weather resistance, OHP transparency, and dispersibility in the toner. The content of the colorant is preferably from 1.0 to 20.0 mass parts per 100.0 mass parts of the binder resin. When a magnetic particle is used as the colorant, the content thereof is preferably from 40.0 to 150.0 mass parts per 100.0 mass parts of the binder resin.

A charge control agent may be included in the toner particle as necessary. A charge control agent may also be added externally to the toner particle. By compound a charge control agent, it is possible to stabilize the charging properties and control the triboelectric charge quantity at a level appropriate to the developing system. A known charge control agent may be used, and a charge control agent capable of providing a rapid charging speed and stably maintaining a uniform charge quantity is especially desirable.

Organic metal compounds and chelate compounds are effective as charge control agents for giving the toner a negative charge, and examples include monoazo metal compounds, acetylacetone metal compounds, and metal compounds using aromatic oxycarboxylic acids, aromatic dicarboxylic acids, oxycarboxylic acids and dicarboxylic acids. Examples of charge control agents for giving the toner a positive charge include nigrosin, quaternary ammonium salts, metal salts of higher fatty acids, diorganotin borates, guanidine compounds and imidazole compounds. The content of the charge control agent is preferably from 0.01 to 20.0 mass parts, or more preferably from 0.5 to 10.0 mass parts per 100.0 mass parts of the toner particle.

The toner particle may be used as-is as a toner, but a toner may, if necessary, also be formed by mixing an external additive or the like so as to attach the external additive to the surface of the toner particle. Examples of the external additive include inorganic fine particles selected from the group consisting of silica fine particles, alumina fine particles and titania fine particles, and composite oxides of these. Examples of composite oxides include silica-aluminum fine particles and strontium titanate fine particles. The content of the external additive is preferably from 0.01 parts by mass to 8.0 parts by mass, and more preferably from 0.1 parts by mass to 4.0 parts by mass, relative to 100 parts by mass of the toner particle.

The weight-average particle diameter (D4) of the toner is not particularly limited, but is preferably from 4.0 to 12.0 μm, and more preferably from 6.0 to 8.0 μm.

Within the scope of the present configuration, the toner particle may be manufactured by any known conventional method such as suspension polymerization, emulsion aggregation, dissolution suspension or pulverization, but is preferably manufactured by a suspension polymerization method.

The following describes the suspension polymerization method in detail. A polymerizable monomer composition is prepared by, for example, mixing the crystalline resin C synthesized in advance and polymerizable monomers for generating the amorphous resin A, and other materials such as a colorant, a release agent, and a charge control agent, as necessary, and uniformly dissolving or dispersing the materials.

Thereafter, the polymerizable monomer composition is dispersed in an aqueous medium using a stirrer or the like to prepare a suspended particle of the polymerizable monomer composition. Thereafter, the polymerizable monomers contained in the particle are polymerized using an initiator or the like to obtain a toner particle. After polymerization has finished, the toner particle is filtered, washed, and dried using known methods, and an external additive is added as necessary to obtain the toner.

A known polymerization initiator may be used. Examples of the polymerization initiator include: azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methylethylketone peroxide, diisopropyl peroxycarbonate, cumene hydroperoxide, 2,4-dichlorobenzoyl peroxide, and lauroyl peroxide. Also, a known chain transfer agent and a known polymerization inhibitor may be used.

The aqueous medium may contain an inorganic or organic dispersion stabilizer. A known dispersion stabilizer may be used. Examples of inorganic dispersion stabilizers include: phosphates such as hydroxyapatite, tribasic calcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

On the other hand, examples of organic dispersion stabilizers include polyvinyl alcohol, gelatin, methyl cellulose, methyl hydroxypropyl cellulose, ethyl cellulose, sodium salts of carboxymethyl cellulose, polyacrylic acid and salts thereof, and starch.

In the case where an inorganic compound is used as the dispersion stabilizer, a commercially available inorganic compound may be used as is, or the inorganic compound may be generated in an aqueous medium to obtain a finer particle. For example, in the case of calcium phosphate such as hydroxyapatite or tribasic calcium phosphate, an aqueous solution of the phosphate and an aqueous solution of a calcium salt may be mixed under high-speed stirring conditions.

The aqueous medium may contain a surfactant. A known surfactant may be used. Examples of the surfactant include: anionic surfactants such as sodium dodecylbenzenesulfate and sodium oleate; cationic surfactants; amphoteric surfactants; and nonionic surfactants.

The following describes methods for calculating and measuring various physical properties.

Method for Measuring Storage Elastic Modulus G′

The storage elastic modulus G′ is measured using a viscoelasticity measurement apparatus (rheometer) ARES (manufactured by Rheometrics Scientific Inc.). An overview of the measurement is described in ARES operation manuals 902-30004 (August 1997) and 902-00153 (July 1993) issued by Rheometrics Scientific Inc., as follows.

Measurement jig: torsion rectangular

Measurement sample: A rectangular parallelepiped sample with a width of 12 mm, a height of 20 mm, and a thickness of 2.5 mm is produced from the toner using a pressure molding machine (25 kN is maintained for 30 minutes at normal temperature). A 100-kN press NT-100H manufactured by NPa System Co., Ltd., is used as the pressure molding machine.

After the jig and the sample are left to stand at normal temperature (23° C.) for 1 hour, the sample is attached to the jig (see the Figure). As shown in the Figure, the sample 100 is fixed in such a manner that a measurement portion have a width of 12 mm, a thickness of 2.5 mm, and a height of 10 mm. The sample 100 is fixed in the fixing holder 110 using the fixing screw 111. The reference number 120 is the motive power transmitting member 120. After the temperature is adjusted to a measurement start temperature of 30° C. for 10 minutes, measurement is carried out under the following settings.
Measurement frequency: 6.28 rad/s
Measurement strain setting: Initial value is set to 0.1%, and measurement is carried out in an automatic measurement mode.
Sample elongation correction: Adjusted in the automatic measurement mode.
Measurement temperature: The temperature is increased from 30° C. to 150° C. at a rate of 2° C./min.
Measurement interval: Viscoelasticity data is measured at intervals of 30 seconds, i.e., intervals of 1° C.

The data is transferred via an interface to RSI Orchestrator (soft for control, data collection and analysis) (manufactured by Rheometrics Scientific Inc.) that runs on Windows2000 manufactured by Microsoft Corporation.

In the measurement data, a temperature at which the storage elastic modulus G′ is 3.0×10⁷ Pa is taken as T1[° C.], a temperature at which the storage elastic modulus G′ is 1.0×10⁷ Pa is taken as T2[° C.], and a temperature at which the storage elastic modulus G′ is 3.0×10⁶ Pa is taken as T3[° C.]. Also, a storage elastic modulus at 100° C. is taken as G′ (100).

Method for Measuring Molecular Weight of Toner

The molecular weight (weight-average molecular weight Mw) of THF-soluble matter in the toner is measured using gel permeation chromatography (GPC) as described below. First, the toner is dissolved in tetrahydrofuran (THF) at room temperature over the course of 24 hours. The resulting solution is filtered through a solvent-resistant membrane filter (Maishori Disk, Tosoh Corp.) having a pore diameter of 0.2 □m to obtain a sample solution. The concentration of THF-soluble components in the sample solution is adjusted to about 0.8 mass %. Measurement is performed under the following conditions using this sample solution.
Device: HLC8120 GPC (detector: RI) (Tosoh Corp.)
Columns: Shodex KF-801, 802, 803, 804, 805, 806, 807 (total 7) (Showa Denko)
Eluent: Tetrahydrofuran (THF)
Flow rate: 1.0 mL/min
Oven temperature: 40.0° C.
Sample injection volume: 0.10 mL

A molecular weight calibration curve prepared using standard polystyrene resin (such as TSK standard polystyrene F-850, F-450, F-288, F-128, F-80, F-40, F-20, F-10, F-4, F-2, F-1, A-5000, A-2500, A-1000, A-500, Tosoh Corp.) is used for calculating the molecular weights of the samples.

Method for Separating Crystalline Resin C and Amorphous Resin A from Toner

The crystalline resin C and the amorphous resin A can be separated from the toner using a known method, and the following describes an example of such a method. Gradient LC is used as a method for separating resin components from the toner. With this analysis, it is possible to separate resins included in the binder resin in accordance with polarities of the resins, irrespective of molecular weights.

First, the toner is dissolved in chloroform. Measurement is carried out using a sample that is prepared by adjusting the concentration of the sample to 0.1 mass % using chloroform and filtering the solution using a 0.45-μm PTFE filter. Gradient polymer LC measurement conditions are shown below.

Apparatus: UltiMate 3000 (manufactured by Thermo Fisher Scientific Inc.)

Mobile phase: A chloroform (HPLC), B acetonitrile (HPLC)

Gradient: 2 min (A/B=0/100)→25 min (A/B=100/0)

(The gradient of the change in mobile phase was adjusted to be linear.)

Flow rate: 1.0 mL/min

Injection: 0.1 mass %×20 μL

Column: Tosoh TSKgel ODS (4.6 mm φ×150 mm×5 μm)

Column temperature: 40° C.

Detector: Corona Charged Particle Detector (Corona-CAD) (Manufactured by Thermo Fisher Scientific Inc.)

In a time-intensity graph obtained through the measurement, the resin components can be separated into two peaks in accordance with their polarities. It is possible to separate the two types of resins by thereafter carrying out the above-described measurement again and performing isolation at times corresponding to valleys after the respective peaks. DSC measurement is performed on the separated resins, and a resin that has a melting point peak is taken as the crystalline resin C, and a resin that does not have a melting point peak is taken as the amorphous resin A.

Note that if the toner contains a release agent, it is necessary to separate the release agent from the toner. The release agent is separated by separating components having a molecular weight of 2000 or less using recycle HPLC. The following describes a measurement method. First, a chloroform solution of the toner is prepared using the above-described method. The obtained solution is filtered using a solvent-resistant membrane filter “Maishori Disk” (manufactured by Tosoh Corporation) having a pore diameter of 0.2 μm to obtain a sample solution. Note that the concentration of chloroform-soluble matter in the sample solution is adjusted to 1.0 mass %. Measurement is carried out using the sample solution under the following conditions.
Apparatus: LC-Sakura NEXT (manufactured by Japan Analytical Industry Co., Ltd.)
Column: JAIGEL2H, 4H (manufactured by Japan Analytical Industry Co., Ltd.)
Eluent: chloroform
Flow rate: 10.0 ml/min
Oven temperature: 40.0° C.
Sample injection amount: 1.0 ml

The molecular weight of the sample is calculated using a molecular weight calibration curve obtained using standard polystyrene resins (e.g., “TSK standard polystyrene F-850, F-450, F-288, F-128, F-80, F-40, F-20, F-10, F-4, F-2, F-1, A-5000, A-2500, A-1000, A-500” (product name) manufactured by Tosoh Corporation). The release agent is removed from the toner by repeatedly performing isolation of components having a molecular weight of 2000 or less using the obtained molecular weight curve.

Method for Measuring Percentages of Contents of Various Monomer Units in Resin

The percentages of contents of various monomer units in a resin are measured using ¹H-NMR under the following conditions. The crystalline resin C and the amorphous resin A isolated using the above-described method can be used as measurement samples.

Measurement apparatus: FT NMR apparatus JNM-EX400 (manufactured by JEOL Ltd.)

Measurement frequency: 400 MHz

Pulse condition: 5.0 μs

Frequency range: 10500 Hz

Cumulative number of times: 64 times

Measurement temperature: 30° C.

Sample: Prepared by placing 50 mg of a measurement sample in a sample tube having an inner diameter of 5 mm, adding deuterated chloroform (CDCl₃) as a solvent, and dissolving the measurement sample in a thermostatic chamber at 40° C. The structure of each monomer unit is identified by analyzing an obtained ¹H-NMR chart. The following describes measurement of the percentage of the content of the monomer unit (a) in the crystalline resin C as an example. In the obtained ¹H-NMR chart, a peak that is independent of peaks attributed to constituents of other monomer units is selected from among peaks attributed to constituents of the monomer unit (a), and an integration value S1 of the selected peak is calculated. An integration value is also calculated in the same manner with respect to other monomer units included in the crystalline resin C.

If monomer units constituting the crystalline resin C are the monomer unit (a) and another monomer unit, the percentage of the content of the monomer unit (a) is determined using the integration value 51 and an integration value S2 of a peak calculated for the other monomer unit. Note that n1 and n2 each represent the number of hydrogen atoms included in a constituent to which the peak focused on with respect to the corresponding unit is attributed.

Percentage (mol %) of content of monomer unit (a)={(S1/n1)/((S1/n1)+(S2/n2))}×100

In cases where the crystalline resin C includes two or more types of other monomer units, the percentage of the content of the monomer unit (a) can be calculated in the same manner (using S3 . . . Sx and n3 . . . nx).

If a polymerizable monomer that does not include a hydrogen atom in constituents other than a vinyl group is used, measurement is carried out using ¹³C-NMR and setting the measurement atomic nucleus to ¹³C in a single pulse mode, and calculation is performed in the same manner using ¹H-NMR. The percentage of the content of each monomer unit is converted to a value expressed in mass % by multiplying the percentage (mol %) of the monomer unit calculated as described above by the molecular weight of the monomer unit. Measurement is carried out for the amorphous resin A as well using the same method.

Observation of a Matrix Domain Structure in a Cross Section of Toner, Area Ratio of Domains, and Number-Basis Average Surface Area of Domains

The state in which the matrix-domain structure (sea-island structure) is present in a toner cross section is ascertained by observing the toner cross section using a scanning transmission electron microscope. Toner cross sections are observed after the toner has been stained with ruthenium. Specifically, a cross-sectional image of the toner is herein a cross-sectional image of the ruthenium-stained toner; the procedure for observing toner cross sections is as follows.

The toner is enveloped in a visible-light-curable resin (D-800, by Nisshin-EM Co., Ltd.) so that the toner is dispersed as thoroughly as possible, and the resin is cut to a thickness of 100 nm using an ultrasonic ultramicrotome (UC7, by Leica Microsystems GmbH).

The obtained section sample is stained for 15 minutes in a RuO₄ gas atmosphere, at 500 Pa, using a vacuum staining device (VSC4R1H, by Filgen, Inc.), whereupon STEM images are acquired using a scanning transmission electron microscope (JEM2800, by JEOL Ltd.). The degree of staining in the above staining conditions differs between the crystalline resin C and the amorphous resin A; this allows confirming, on the basis of resulting contrast difference, a state in which the matrix-domain structure is present.

That is, contrast is sharp and observation easy, by virtue of the fact that the crystalline resin C becomes more stained with ruthenium than the amorphous resin A is. The amount of ruthenium atoms varies depending on the strength of staining, and hence intensely stained areas, which contain a larger number of these atoms and do not let electron beams through, appear black on an observation image, whereas lightly stained areas let electron beams readily through, and appear white on the observation image.

A dark field (STEM-DF) image is acquired herein with observation conditions set to an acceleration voltage of 200 kV, STEM probe size of 1 nm, image size of 1024×1024 pixels, and 30,000 magnifications.

Contrast and Brightness are adjusted so that brightness at a time where the portion having a resin component as a main component takes up the greatest number of pixels, in a below-described brightness histogram by IMAGE J, exhibits a value of 150.

Brightness can be adjusted using Microsoft Photo in a case where brightness is from 140 and 160.

In a case where brightness is other than the above, staining conditions are modified once more, and the STEM image is obtained again.

To select then a toner cross-sectional image, the weight-average particle diameter (D4) of the toner is measured in accordance with the below-described measurement method, and thereafter there are arbitrarily selected 10 toner cross sections having a major axis diameter that is from 0.8 to 1.1 times the above D4. Images are acquired so as to preclude two or more toner particles from entering the field of view of one image.

The brightness histogram is acquired through analysis of the STEM images of the toner cross sections, obtained in accordance with the above method, using image processing software Image J (developed by Wayne Rashand). Specifically, the brightness histogram is a brightness histogram obtained by measuring a brightness spectrum of 256 gradations of an image obtained through image analysis of the toner cross sections. The concrete procedure is as follows.

Firstly, a backscattered electron image to be analyzed is converted to an 8-bit image using Type in the Image menu.

Next, the range to be analyzed is designated only inward of the contour of the toner. The contour of toner is defined by a boundary line that is the interface between the visible-light-curable resin and the toner cross sections. Areas outside the range to be analyzed are deleted by way of Clear Outside in the Edit menu.

Further, the Median diameter is set to 2.0 pixels using Filters in the Process menu, to reduce image noise.

Next, Threshold from Adjust in the Image menu is selected, the position of the lower bar is set to 150, and Apply is selected. Then List is displayed, and a white ratio is calculated on the basis of the number of 0-pixels relative to the total number of pixels. This white ratio constitutes the area ratio of the domains (islands).

Next, Scale adjustment, Binary and Watershed are selected using a similar binarized image, and a measurement is performed, to thereby calculate the average surface area of white portions. The number-basis average surface area of the white portions is taken as the number-basis average surface area of the domains.

Similar image analysis is performed on the ten STEM images of the toner cross sections, and the above values are calculated. The obtained arithmetic mean of the values for the ten images is taken as a physical property value of the respective toner.

Elucidation of the Matrix-Domain Structure

The matrix-domain structure corresponds for instance to a state, in a toner cross-sectional image, in which the matrix is contiguously connected within the image, and the domains are isolated by the matrix.

In the STEM images of the toner cross sections, the black-stained contiguous portion is the matrix of the crystalline resin C.

The isolated portions that are not stained black in the STEM images of the toner cross sections are the domains of the amorphous resin A.

Specifically, a matrix-domain structure is deemed to be present in a case where there is observed one or more domains isolated in a matrix, as described above, in the ten STEM images of the toner cross sections.

Measurement of the Weight-Average Particle Diameter (D4) of the Toner

The weight-average particle diameter (D4) of the toner is calculated as follows. The measuring device used herein is a precision particle diameter distribution measuring device “Coulter Counter Multisizer 3” (registered trademark, by Beckman Coulter, Inc.) relying on a pore electrical resistance method and equipped with a 100 μm aperture tube. The measurement conditions are set, and measurement data analyzed, using dedicated software (Beckman Coulter Multisizer 3, Version 3.51″, by Beckman Coulter, Inc.) ancillary to the device. The measurements are performed in 25,000 effective measurement channels.

An aqueous electrolyte solution used in the measurements can be prepared through dissolution of special-grade sodium chloride to a concentration of about 1.0% in ion-exchanged water; for instance “ISOTON II” (by Beckman Coulter, Inc.) can be used herein as the aqueous electrolyte solution.

The dedicated software is set up as follows, prior to measurement and analysis.

In the screen of “Modification of the Standard Measurement Method (SOMME)” of the dedicated software, a Total Count of the Control Mode is set to 50,000 particles, the number of measurements is set to one, and a Kd value is set to a value obtained using “Standard particles 10.0 μm” (by Beckman Coulter). The “Threshold/Noise Level Measurement Button” is pressed, to thereby automatically set a threshold value and a noise level. Then the current is set to 1600 μA, the gain is set to 2, the electrolyte solution is set to ISOTON II, and “Flushing of the Aperture Tube Following Measurement” is ticked.

In the screen for “Setting Conversion from Pulses to Particle Diameter” of the dedicated software, the Bin Interval is set to a logarithmic particle diameter, the Particle Diameter Bin is set to 256 particle diameter bins, and the Particle Diameter Range is set to a range from 2 μm to 60 μm.

The concrete measuring method is as follows.

(1) Herein 200.0 mL of the aqueous electrolyte solution are placed in a 250 mL round-bottomed glass beaker ancillary to Multisizer 3, and the beaker is set on a sample stand and is stirred counterclockwise with a stirrer rod at 24 rotations/second. Dirt and air bubbles are then removed from the aperture tube by way of the “Aperture Flush” function of the dedicated software.

(2) Then about 30.0 mL of the aqueous electrolyte solution are placed in a 100 mL flat-bottomed glass beaker. To the beaker there is added a dispersing agent in the form of 0.3 mL of a dilution of “Contaminon N” (10 mass % aqueous solution of a pH-7 neutral detergent for precision measuring instruments, made up of a nonionic surfactant, an anionic surfactant and an organic builder, by Wako Pure Chemical Industries, Ltd.), diluted thrice by mass in ion-exchanged water.

(3) An ultrasonic disperser is prepared having an electrical output of 120 W “Ultrasonic Dispersion System Tetora 150” (by Nikkaki Bios Co., Ltd.), internally equipped with two oscillators that oscillate at a frequency of 50 kHz and are disposed at phases offset by 180 degrees. Then 3.3 L of ion-exchanged water are charged into a water tank of the ultrasonic disperser, and 2.0 mL of Contaminon N are added to the water tank.

(4) The beaker in (2) is set in a beaker-securing hole of the ultrasonic disperser, which is then operated. The height position of the beaker is adjusted so as to maximize a resonance state at the liquid surface of the aqueous electrolyte solution in the beaker.

(5) With the aqueous electrolyte solution in the beaker of (4) being ultrasonically irradiated, about 10 mg of the toner particle are then added little by little to the aqueous electrolyte solution, to be dispersed therein. The ultrasonic dispersion treatment is further continued for 60 seconds. The water temperature in the water tank during ultrasonic dispersion is adjusted as appropriate so as to range from 10° C. to 40° C.

(6) The aqueous electrolyte solution in (5) containing for instance the dispersed toner particle is added dropwise, using a pipette, to the round-bottomed beaker of (1) set in the sample stand, and the measurement concentration is adjusted to about 5%. A measurement is then performed until the number of measured particles reaches 50,000.

(7) Measurement data is analyzed using the dedicated software ancillary to the apparatus, to calculate the weight-average particle diameter (D4). The “Average Diameter” in the “Analysis/Volume Statistics (arithmetic mean)” screen, upon setting of Graph/volume % in the dedicated software, yields herein the weight-average particle diameter (D4).

Measurement of Percentage of Content of Crystalline Resin C in Toner

The percentage of the content of the crystalline resin C in the toner is calculated based on the mass of the toner before the toner is dissolved in chloroform in the above-described method for separating the crystalline resin C and the amorphous resin A from the toner and the mass of the separated crystalline resin C.

### EXAMPLES

The following describes the disclosure in more detail using examples, but the invention is not limited by the examples. In formulations described below, “parts” means “parts by mass”, unless otherwise stated.

Preparation of Crystalline Resin C-1

The following materials were placed in a reaction vessel equipped with a reflux condenser tube, a stirrer, a thermometer, and a nitrogen introduction tube in a nitrogen atmosphere.

| | |
|---|---|
| Toluene | 100.0 parts |
| Monomer composition | 100.0 parts |

(The Monomer Composition was Prepared by Mixing the Following Monomers at a Ratio Shown Below.)

| | |
|---|---|
| (Behenyl acrylate (monomer (a)) | 80.0 parts) |
| (Styrene | 18.0 parts) |
| (Methacrylic acid | 2.0 parts) |
| Polymerization initiator: t-butyl peroxypivalate (PERBUTYL | 0.5 parts |
| PV manufactured by NOF Corporation) | |

The contents in the reaction vessel were heated to 70° C. while being stirred at 200 rpm for 12 hours to cause a polymerization reaction, and thus a solution in which a polymer of the monomer composition was dissolved in toluene was obtained. Subsequently, the temperature of the solution was reduced to 25° C., and then the solution was added to 1000.0 parts of methanol while being stirred to cause precipitation of methanol-insoluble matter. The obtained methanol-insoluble matter was filtered, washed with methanol, and dried in a vacuum at 40° C. for 24 hours to obtain a crystalline resin C-1.

Preparation of Crystalline Resins C-2 to C-10

Crystalline resins C-2 to C-10 were prepared in the same way as in the preparation of crystalline resin C-1, but herein the addition amount of the monomer composition was modified as given in Table 1.

TABLE 1

| | | | | Other monomer 1 | | Other monomer 2 | |
|---|---|---|---|---|---|---|---|
| Crystalline | Monomer (a) | | | Monomer | Mass | Monomer | Mass |
| resin No. | Monomer species | n | Mass ratio % | species | ratio % | species | ratio % |
| C-1 | Behenyl acrylate | 21 | 80.0 | Styrene | 18.0 | Methacrylic acid | 2.0 |
| C-2 | Behenyl acrylate | 21 | 50.0 | Styrene | 48.0 | Methacrylic acid | 2.0 |
| C-3 | Behenyl acrylate | 21 | 48.0 | Styrene | 50.0 | Methacrylic acid | 2.0 |
| C-4 | Behenyl acrylate | 21 | 98.0 | Styrene | 0.0 | Methacrylic acid | 2.0 |
| C-5 | Behenyl acrylate | 21 | 99.0 | Styrene | 0.0 | Methacrylic acid | 1.0 |
| C-6 | Stearyl acrylate/ | 17/21 | 80.0(40.0/40.0) | Styrene | 18.0 | Methacrylic acid | 2.0 |
| | behenyl acrylate | | | | | | |
| C-7 | Myricyl acrylate/ | 29/21 | 80.0(75.0/5.0) | Styrene | 18.0 | Methacrylic acid | 2.0 |
| | behenyl acrylate | | | | | | |
| C-8 | Myricyl acrylate/ | 29/21 | 80.0(15.0/65.0) | Styrene | 18.0 | Methacrylic acid | 2.0 |
| | behenyl acrylate | | | | | | |
| C-9 | Stearyl acrylate/ | 17/21 | 80.0(60.0/20.0) | Styrene | 18.0 | Methacrylic acid | 2.0 |
| | behenyl acrylate | | | | | | |
| C-10 | Myricyl acrylate/ | 29/21 | 80.0(30.0/50.0) | Styrene | 18.0 | Methacrylic acid | 2.0 |
| | behenyl acrylate | | | | | | |

Production Example of Toner 1

Production of a Toner by Suspension Polymerization

Production of Toner particle 1

| | |
|---|---|
| Methyl methacrylate (monomer (b)) | 38.0 parts |
| Lauryl acrylate (monomer (c)) | 20.0 parts |
| n-butyl acrylate | 9.0 parts |
| Colorant carbon black | 8.0 parts |

A mixture made up of the above materials was prepared. The mixture was placed in an attritor (by Nippon Coke & Engineering Co., Ltd.), and was dispersed at 200 rpm for 2 hours using zirconia beads having a diameter of 5 mm, to yield a starting material dispersion.

On the other hand, 735.0 parts of ion exchange water and 16.0 parts of tribasic sodium phosphate (dodeca hydrate) were added into a vessel equipped with a high-speed stirrer Homomixer (manufactured by Primix Corporation) and a thermometer, and heated to 60° C. while being stirred at 12000 rpm. A calcium chloride aqueous solution obtained by dissolving 9.0 parts of calcium chloride (dihydrate) in 65.0 parts of ion exchange water was added into the vessel, and the contents in the vessel were stirred at 12000 rpm for 30 minutes while the temperature was kept at 60° C. Then, 10% hydrochloric acid was added to adjust pH to 6.0, and thus an aqueous medium in which an inorganic dispersion stabilizer containing hydroxyapatite was dispersed in water was obtained.

Subsequently, the raw material dispersed solution described above was transferred into a vessel equipped with a stirrer and a thermometer, and heated to 60° C. while being stirred at 100 rpm.

| | |
|---|---|
| Crystalline resin C-1 | 33.0 parts |
| Release agent | 9.0 parts |
| (Release agent: DP18 (dipentaerythritol stearate wax, | |
| melting point: 79° C., manufactured by Nippon Seiro Co., | |
| Ltd.)) | |

The materials shown above were added into the vessel, the contents in the vessel were stirred at 100 rpm for 30 minutes while the temperature was kept at 60° C., then 5.0 parts of t-butyl peroxypivalate (PERBUTYL PV manufactured by NOF Corporation) was added as a polymerization initiator, and the contents were further stirred for 1 minute, and then added into the aqueous medium that was being stirred at 12000 rpm using the high-speed stirrer. Stirring by the high-speed stirrer was continued at 12000 rpm for 20 minutes while the temperature was kept at 60° C. to obtain a granulation solution.

The granulation solution was transferred into a reaction vessel equipped with a reflux condenser tube, a stirrer, a thermometer, and a nitrogen introduction tube, and heated to 70° C. while being stirred at 150 rpm in a nitrogen atmosphere. Polymerization was carried out for 12 hours at 150 rpm while the temperature was kept at 70° C. to obtain a toner particle dispersed solution.

The obtained toner particle dispersed solution was cooled to 45° C. while being stirred at 150 rpm, and then subjected to heat treatment for 5 hours while the temperature was kept at 45° C. Thereafter, dilute hydrochloric acid was added until pH reached 1.5 while stirring was continued to dissolve the dispersion stabilizer. Solid contents were filtered, sufficiently washed with ion exchange water, and then dried in a vacuum at 30° C. for 24 hours to obtain Toner particle 1.

Preparation of Toner 1

To 98.0 parts of the above Toner particle 1 there were added 2.0 parts of silica fine particles as an external additive (hydrophobized by hexamethyldisilazane; number-average particle diameter of primary particles: 10 nm; BET specific surface area: 170 m 2/g), and the whole was mixed for 15 minutes at 3000 rpm using a Henschel mixer (by Nippon Coke & Engineering Co., Ltd.), to yield Toner 1. Table 3 sets out the physical properties of the obtained Toner 1.

Production Examples of Toners 2 to 23

Toner particles 2 to 23 were obtained in the same way as in the product example of Toner 1, but herein the types and amounts of materials that were used and the reaction temperature were modified as given in Table 2.

The same external addition as in Toner 1 was further performed, to yield Toners 2 to 23. Table 3 sets out the physical properties of the toners.

Production Examples of Comparative Toners 1 to 9

Comparative toner particles 1 to 9 were obtained in the same way as in the production example of Toner 1, but herein the types and amounts of materials that were used and the reaction temperature were modified as given in Table 2, to yield Comparative toner particles 1 to 9.

The same external addition as in Toner 1 was further performed, to yield Comparative toners 1 to 9. Table 3 sets out the physical properties of the toners.

TABLE 2

| | | | | | | | | | | | | Polymer- | Polymer- |
|---|---|---|---|---|---|---|---|---|---|---|---|---|---|
| | | | | | | | | | | | | ization on | ization |
| | | | | | | | | Other | | Other | | initiator | reaction |
| | Toner | Crystalline | | Monorner (b) | | Monomer (C) | | monomer 3 | | monomer 4 | | t-butyl | temper- |
| | particle | r [symbol] sin | | Monomer | | Monomer | | Monomer | | Monomer | | peroxy [symbol] | ature |
| Toner | No. | No. | Parts | species | Parts | species | Parts | species | Parts | species | Parts | Parts | ° C. |
| Toner 1 | 1 | C-1 | 33.0 | Methyl | 38.0 | Lauryl | 20.0 | Butyl | 9.0 | — | — | 5.0 | 70 |
| | | | | [symbol] | | acrylate | | acrylate | | | | | |
| Toner 2 | 2 | C-1 | 33.0 | t-butyl | 3 [symbol] .0 | Lauryl | 20.0 | Butyl | 9.0 | — | — | 5.0 | 70 |
| | | | | methacrylate | | acrylate | | acrylate | | | | | |
| Toner 3 | 3 | C-1 | 13.0 | Methyl | 49.0 | Lauryl | 2 [symbol] .0 | Butyl | 12.0 | — | — | 5.0 | 70 |
| | | | | [symbol] | | acrylate | | acrylate | | | | | |
| Toner 4 | 4 | C-1 | 12.0 | Methyl | 50.0 | Lauryl | 2 [symbol] . [symbol] | Butyl | 12.0 | — | — | 5.0 | 70 |
| | | | | [symbol] | | acrylate | | acrylate | | | | | |
| Toner 5 | 5 | C-1 | 72.0 | Methyl | 16.0 | Lauryl | 9.0 | Butyl | 3.0 | — | — | 5.0 | 70 |
| | | | | [symbol] | | acrylate | | acrylate | | | | | |
| Toner 6 | 6 | C-1 | 74.0 | Methyl | 15.0 | Lauryl | 8.0 | Butyl | 3.0 | — | — | [symbol] .0 | 70 |
| | | | | [symbol] | | acrylate | | acrylate | | | | | |
| Toner 7 | 7 | C-2 | 33.0 | Methyl | 38.0 | Lauryl | 20.0 | Butyl | 9.0 | — | — | [symbol] .0 | 70 |
| | | | | [symbol] | | acrylate | | acrylate | | | | | |
| Toner 8 | 8 | C-3 | 33.0 | Methyl | 38.0 | Lauryl | 20.0 | Butyl | 9.0 | — | — | [symbol] .0 | 70 |
| | | | | [symbol] | | acrylate | | acrylate | | | | | |
| Toner 9 | 9 | C-4 | 33.0 | Methyl | 3 [symbol] .0 | Lauryl | 20.0 | Butyl | 9.0 | — | — | [symbol] .0 | 70 |
| | | | | [symbol] | | acrylate | | acrylate | | | | | |
| Toner 10 | 10 | C-5 | 33.0 | Methyl | 3 [symbol] .0 | Lauryl | 20.0 | Butyl | 9.0 | — | — | 5.0 | 70 |
| | | | | [symbol] | | acrylate | | acrylate | | | | | |
| Toner 11 | 11 | C-6 | 33.0 | Methyl | 3 [symbol] .0 | Lauryl | 20.0 | Butyl | 9.0 | — | — | 5.0 | 70 |
| | | | | [symbol] | | acrylate | | acrylate | | | | | |
| Toner 12 | 12 | C-7 | 33.0 | Methyl | 3 [symbol] .0 | Lauryl | 20.0 | Butyl | 9.0 | — | — | 5.0 | 70 |
| | | | | [symbol] | | acrylate | | acrylate | | | | | |
| Toner 13 | 13 | C-8 | 33.0 | Methyl | 3 [symbol] .0 | Lauryl | 20.0 | Butyl | 9.0 | — | — | 5.0 | 70 |
| | | | | [symbol] | | acrylate | | acrylate | | | | | |
| Toner 14 | 14 | C-1 | 13.0 | Methyl | 4 [symbol] .0 | Lauryl | 2 [symbol] . [symbol] | Butyl | 12.0 | — | — | 9.0 | 73 |
| | | | | [symbol] | | acrylate | | acrylate | | | | | |
| Toner 15 | 15 | C-1 | 12.0 | Methyl | [symbol] 0.0 | Lauryl | 2 [symbol] . [symbol] | Butyl | 12.0 | — | — | [symbol] .0 | 73 |
| | | | | [symbol] | | acrylate | | acrylate | | | | | |
| Toner 16 | 16 | C-1 | 10.0 | Methyl | 51.0 | Lauryl | 2 [symbol] . [symbol] | Butyl | 13.0 | — | — | [symbol] .0 | 73 |
| | | | | [symbol] | | acrylate | | acrylate | | | | | |
| Toner 17 | 17 | C-1 | 7.0 | Methyl | 52.0 | Lauryl | 27.0 | Butyl | 14.0 | — | — | [symbol] .0 | 73 |
| | | | | [symbol] | | acrylate | | acrylate | | | | | |
| Toner 18 | 18 | C-1 | 33.0 | Styrene | 38.0 | Lauryl | 20.0 | Butyl | [symbol] .0 | — | — | 5.0 | 70 |
| | | | | | | acrylate | | acrylate | | | | | |
| Toner 19 | 19 | C-1 | 50.0 | Styrene | 31.0 | Lauryl | 15.0 | Butyl | 4.0 | — | — | 5.0 | 70 |
| | | | | | | acrylate | | acrylate | | | | | |
| Toner 20 | 20 | C-1 | 33.0 | Stuene | 3 [symbol] .0 | Lauryl | 20.0 | Butyl | [symbol] .0 | — | — | 5.0 | 70 |
| | | | | | | acrylate | | acrylate | | | | | |
| Toner 21 | 21 | C-1 | 33.0 | Methyl | 3 [symbol] .0 | Lauryl | 19.0 | Butyl | [symbol] .0 | HDDA | 1.0 | 5.0 | 70 |
| | | | | [symbol] | | acrylate | | acrylate | | | | | |
| Toner 22 | 22 | C-1 | 12.0 | Methyl | 50.0 | Lauryl | 2 [symbol] .0 | Butyl | 11.5 | HDDA | 0.5 | 5.0 | 70 |
| | | | | [symbol] | | acrylate | | acrylate | | | | | |
| Toner 23 | 23 | C-4 | 74.0 | Methyl | 15.0 | Octyl | 8.0 | Butyl | 3.0 | — | — | 5.0 | 70 |
| | | | | [symbol] | | acrylate | | acrylate | | | | | |
| Comparative | Comparative 1 | C-3 | 50.0 | Methyl | 2 [symbol] .0 | Lauryl | 15.0 | Butyl | 7.0 | — | — | 5.0 | 70 |
| toner 1 | | | | [symbol] | | acrylate | | acrylate | | | | | |
| Comparative | Comparative 2 | C-9 | 33.0 | Methyl | 3 [symbol] .0 | Lauryl | 20.0 | Butyl | 9.0 | — | — | 5.0 | 70 |
| toner 2 | | | | [symbol] | | acrylate | | acrylate | | | | | |
| Comparative | Comparative 3 | C-10 | 33.0 | Methyl | 38.0 | Lauryl | 20.0 | Butyl | 9.0 | — | — | 5.0 | 70 |
| toner 3 | | | | [symbol] | | acrylate | | acrylate | | | | | |
| Comparative | Comparative 4 | C-3 | 7.0 | Methyl | 52.0 | Lauryl | 27.0 | Butyl | 14.0 | — | — | 9.0 | 73 |
| toner 4 | | | | [symbol] | | acrylate | | acrylate | | | | | |
| Comparative | Comparative 5 | C-4 | 74.0 | Methyl | 15.0 | Lauryl | [symbol] .0 | Butyl | 3.0 | — | — | [symbol] .0 | 70 |
| toner 5 | | | | [symbol] | | acrylate | | acrylate | | | | | |
| Comparative | Comparative 6 | — | — | Methyl | 57.0 | Lauryl | 30.0 | Butyl | 13.0 | — | — | 5.0 | 70 |
| toner 6 | | | | [symbol] | | acrylate | | acrylate | | | | | |
| Comparative | Comparative 7 | C-1 | 5.0 | Methyl | 5 [symbol] .0 | Lauryl | 27.0 | Butyl | 15.0 | — | — | 9.0 | 73 |
| toner 7 | | | | [symbol] | | acrylate | | acrylate | | | | | |
| Comparative | Comparative 8 | C-1 | [symbol] 0.0 | Methyl | 12.0 | Lauryl | [symbol] .0 | Butyl | 2.0 | — | — | 5.0 | 70 |
| toner 8 | | | | [symbol] | | acrylate | | acrylate | | | | | |
| Comparative | Comparative 9 | C-1 | 20.0 | Styrene | 45.0 | Lauryl | 24.0 | Butyl | 11.0 | — | — | 5.0 | 70 |
| toner 9 | | | | | | acrylate | | acrylate | | | | | |

[symbol]

indicates data missing or illegible when filed

In the table, butyl acrylate as Other monomer 3 is n-butyl acrylate. Further, HDDA denotes hexanediol diacrylate.

TABLE 3

| | | Toner | Weight- | | | | | | | |
|---|---|---|---|---|---|---|---|---|---|---|
| | Toner | particle | average | | | | | | | Domain |
| Toner | particle | production | particle | | | | T3 − | | Domain | average |
| No. | No. | method | size (D4) | T1 | T2 | T3 | T1 | G′(100) | area % | area nm² |
| 1 | 1 | SP | 7.0 | 54.0 | 58.0 | 60.0 | 6.0 | 1.0 × 10⁵ Pa | 74 | 300 |
| 2 | 2 | SP | 7.0 | 54.0 | 58.0 | 60.0 | 6.0 | 1.0 × 10⁵ Pa | 73 | 310 |
| 3 | 3 | SP | 7.1 | 54.0 | 59.0 | 62.0 | 8.0 | 6.5 × 10⁵ Pa | 87 | 210 |
| 4 | 4 | SP | 7.1 | 54.0 | 59.0 | 63.0 | 9.0 | 6.7 × 10⁵ Pa | 88 | 200 |
| 5 | 5 | SP | 6.9 | 54.0 | 58.0 | 60.0 | 6.0 | 5.0 × 10⁴ Pa | 48 | 350 |
| 6 | 6 | SP | 7.0 | 54.0 | 58.0 | 60.0 | 6.0 | 4.8 × 10⁴ Pa | 46 | 370 |
| 7 | 7 | SP | 7.0 | 51.0 | 56.0 | 60.0 | 9.0 | 4.0 × 10⁵ Pa | 68 | 1000 |
| 8 | 8 | SP | 7.0 | 51.0 | 56.0 | 60.0 | 9.0 | 4.2 × 10⁵ Pa | 65 | 1200 |
| 9 | 9 | SP | 7.1 | 56.0 | 59.0 | 61.0 | 5.0 | 9.5 × 10⁴ Pa | 74 | 220 |
| 10 | 10 | SP | 7.0 | 56.0 | 59.0 | 61.0 | 5.0 | 8.5 × 10⁴ Pa | 76 | 200 |
| 11 | 11 | SP | 6.9 | 48.0 | 51.0 | 54.0 | 6.0 | 9.0 × 10⁴ Pa | 70 | 2500 |
| 12 | 12 | SP | 7.0 | 60.0 | 63.0 | 66.0 | 6.0 | 1.0 × 10⁵ Pa | 76 | 300 |
| 13 | 13 | SP | 7.1 | 65.0 | 68.0 | 71.0 | 6.0 | 1.0 × 10 [symbol] Pa | 77 | 300 |
| 14 | 14 | SP | 7.0 | 54.0 | 58.0 | 60.0 | 6.0 | 7.0 × 10⁵ Pa | 87 | 130 |
| 15 | 15 | SP | 7.0 | 54.0 | 58.0 | 60.0 | 6.0 | 7.3 × 10⁵ Pa | 88 | 120 |
| 16 | 16 | SP | 7.0 | 54.0 | 58.0 | 60.0 | 6.0 | 8.1 × 10⁵ Pa | 91 | 110 |
| 17 | 17 | SP | 7.1 | 54.0 | 58.0 | 60.0 | 6.0 | 9.5 × 10⁵ Pa | 95 | 100 |
| 18 | 18 | SP | 7.1 | 54.0 | 58.0 | 60.0 | 6.0 | 8.0 × 10⁴ Pa | 74 | 9800 |
| 19 | 19 | SP | 6.9 | 54.0 | 58.0 | 60.0 | 6.0 | 7.2 × 10⁴ Pa | 74 | 11000 |
| 20 | 20 | SP | 7.1 | 54.0 | 58.0 | 60.0 | 6.0 | 6.5 × 10⁴ Pa | 74 | 99000 |
| 21 | 21 | SP | 7.0 | 54.0 | 58.0 | 60.0 | 6.0 | 1.0 × 10 [symbol] Pa | 74 | 300 |
| 22 | 22 | SP | 7.0 | 54.0 | 59.0 | 63.0 | 9.0 | 1.0 × 10 [symbol] Pa | 88 | 200 |
| 23 | 23 | SP | 7.1 | 56.0 | 59.0 | 61.0 | 5.0 | 1.0 × 10⁴ Pa | 46 | 370 |
| C.1 | C.1 | SP | 7.0 | 51.0 | 58.0 | 64.0 | 13.0 | 2.1 × 10⁵ Pa | 65 | 1200 |
| C.2 | C.2 | SP | 6.9 | 46.0 | 48.0 | 52.0 | 6.0 | 9.0 × 10⁴ Pa | 70 | 2500 |
| C.3 | C.3 | SP | 7.0 | 70.0 | 73.0 | 76.0 | 6.0 | 1.0 × 10⁵ Pa | 78 | 300 |
| C.4 | C.4 | SP | 7.1 | 54.0 | 58.0 | 60.0 | 6.0 | 1.4 × 10⁶ Pa | 95 | 100 |
| C.5 | C.5 | SP | 7.0 | 56.0 | 59.0 | 61.0 | 5.0 | 8.2 × 10 [symbol] Pa | 46 | 370 |
| C.6 | C.6 | SP | 6.9 | 63.0 | 70.0 | 85.0 | 22.0 | 1.2 × 10⁵ Pa | — | — |
| C.7 | C.7 | SP | 7.1 | 54.0 | 58.0 | 60.0 | 6.0 | 1.0 × 10 [symbol] Pa | 97 | 100 |
| C.8 | C.8 | SP | 7.0 | 54.0 | 58.0 | 60.0 | 6.0 | 4.1 × 10⁴ Pa | 42 | 370 |
| C.9 | C.9 | SP | 7.0 | 54.0 | 58.0 | 60.0 | 6.0 | 4.5 × 10⁴ Pa | 74 | 130000 |

[symbol]

indicates data missing or illegible when filed

In the above table, “C.” indicates “Comparative”, and “SP” indicates “Suspension polymerization method”.

In Toners 1 to 23 and Comparative Toners 1 to 5 and 7 to 9, a matrix-domain structure having a matrix of crystalline resin C and a domain of the amorphous resin A was found in observations of toner cross sections.

The above analysis revealed that Toners 1 to 23 and Comparative toners 1 to 5 and 7 to 9 contained the crystalline resin C in the same content ratios as in the formulations given in Table 2. In Toners 1 to 23 and Comparative toners 1 to 9, the content ratios of the monomer units that formed the crystalline resin C and the monomer units that formed the amorphous resin A were identical to those of the formulations given in Table 2. The units of the weight-average particle diameter D4 is μm.

### Examples 1 to 23 and Comparative Examples 1 to 9

Evaluation tests were performed on Toners 1 to 23 and Comparative toners 1 to 9. The evaluation methods and evaluation criteria are explained below. Table 4 sets out the evaluation results.

Toner Evaluation Methods

<1>Low-Temperature Fixability

A modified laser beam printer (product name: LBP-7700C, by Canon Inc.) was used as an image forming apparatus for evaluating the low-temperature fixability of the toner. The printer was modified so as to operate even with a fixing unit removed therefrom, and so as to allow freely setting the fixation temperature. The paper used for image outputting was white paper (Red Label 90 g paper).

Firstly, the toner was removed from the interior of a cartridge, whereupon the cartridge was cleaned by air blowing, and was thereafter refilled with 300 g of the respective toner under evaluation. The cartridge was then allowed to stand for 48 hours in an environment at a temperature of 25° C. and humidity of 40% RH, and was fitted to the cyan station of the above printer, under the above environment, with dummy cartridges attached to other stations. Evaluations were performed under the same environment as above.

The process speed was set to 300 mm/s and the initial temperature was set to using the removed fixing unit; then, while the set temperature was sequentially raised in 5° C. increments, the unfixed image was fixed at each corresponding temperature, to yield fixed images at respective temperatures.

The fixed images were visually checked and the lowest temperature at which cold offset did not occur was taken as a fixing onset temperature; herein low-temperature fixability was then evaluated in accordance with the criteria below.

Evaluation Criteria

A: Fixing onset temperature of 100° C. or lower

B: Fixing onset temperature from 105° C. to 110° C.

C: fixing onset temperature from 115° C. to 120° C.

D: Fixing onset temperature of 125° C. or higher

<2>Heat-Resistant Storability

The heat-resistant storability was evaluated to evaluate stability of the toner when the toner was stored. 5 g of the toner was placed in a resin cup with a capacity of 100 ml, and left to stand in an environment at a temperature of 50° C. and a humidity of 40RH % for 3 days, and then a degree of agglomeration of the toner was measured as described below, and evaluated based on a criteria shown below.

A measurement apparatus was prepared by connecting a digital display vibrometer “DIGI-VIBRO MODEL 1332A” (manufactured by Showa Sokki Corporation) to a side surface of a vibration table of “Powder Tester” (manufactured by Hosokawa Micron Corporation). A sieve with an opening size of 38 μm (400 mesh), a sieve with an opening size of 75 μm (200 mesh), and a sieve with an opening size of 150 μm (100 mesh) were overlaid on each other in this order from below on the vibration table of Powder Tester. The measurement was carried out as described below in an environment at a temperature of 23° C. and a humidity of 60% RH.

(1) A vibration width of the vibration table was adjusted in advance such that a displacement value of the digital display vibrometer became 0.60 mm (peak-to-peak).

(2) The toner left to stand for 10 days as described above was left to stand in an environment at a temperature of 23° C. and a humidity of 60% RH for 24 hours in advance, and then 5.00 g of the toner was precisely weighed and gently placed on the uppermost sieve with the opening size of 150

(3) After the sieves were vibrated for 15 seconds, masses of the toner left on the respective sieves were measured, and the degree of agglomeration was calculated using the following expression. Evaluation results are shown in Table 4.

Degree of agglomeration (%)={(mass (g) of sample on sieve with opening size of 150 μm)/5.00 (g)}×100+{(mass (g) of sample on sieve with opening size of 75 μm)/5.00 (g)}×100×0.6+{(mass (g) of sample on sieve with opening size of 38 μm)/5.00 (g)}×100×0.2

Evaluation Criteria

A: The degree of agglomeration was less than 20%

B: The degree of agglomeration was 20% or more and less than 25%.

C: The degree of agglomeration was 25% or more and less than 30%.

D: The degree of agglomeration was 30% or more.

<3>Hot offset resistance

With a highest fixation temperature as the highest temperature at which hot offset was not observed, under the same conditions as those for low-temperature fixability, herein a fixability region was defined as the difference between the highest fixation temperature and the fixing onset temperature. Evaluation criteria for the fixability region were as follows.

A: The temperature at which hot offset does not occur is the fixing onset temperature+60° C. or more

B: The temperature at which hot offset does not occur is the fixing onset temperature+50° C. to less than +60° C.

C: The temperature at which hot offset does not occur is the fixing onset temperature+40° C. to less than +50° C.

D: The temperature at which hot offset does not occur is lower than the fixing onset temperature+40° C.

<4>Stackability

Fixed-image paper at a temperature higher by 20° C. than the fixing onset temperature was evaluated as follows. The image area of the fixed-image paper was laid, facing downward, on 500 sheets of unused paper (Office Planner 64 g/m 2, by Canon Inc.), and then the fixed-image paper was sandwiched by further laying thereon a further 500 sheets of the same type of unused paper. The resulting stack was placed in a thermostatic bath adjusted to 45° C., was allowed to stand there for 72 hours, and was then retrieved from the thermostatic bath.

The reflectance of the portion of the unused paper that was in contact with the image area, in the unused paper that was in contact with the fixed-image paper, was measured, and from the obtained result there was subtracted the reflectance of the portion of the unused paper that was not in contact with the image area, to thereby measure color transfer of the image. Image stackability was evaluated, on the basis of that situation, in accordance with the criteria below. Reflectance was measured using TC-6DS (by Tokyo Denshoku Co., Ltd.).

A: Density of the color transfer portion lower than 0.5%

B: Density of the color transfer portion from 0.5% to less than 1.0%

C: Density of the color transfer portion from 1.0% to less than 2.0%

D: Density of the color transfer portion of 2.0% or higher

<5>Durability Fogging

To evaluate the low-temperature fixability of the toner, a developed solid image was created so that the toner laid-on level on the initial evaluation paper was 0.40 mg/cm², in a high-temperature, high-humidity environment (temperature 32.5° C., humidity 80% RH), using a laser beam printer (product name: LBP-7700C, by Canon Inc.) as an image forming apparatus, and then 3000 prints of the image at a print percentage of 2% were printed out using the above printer.

After allowing the printer to stand for one day, one print of an image having a white background portion was printed out. The reflectance of the obtained image was measured using a reflection densitometer (Reflectometer model TC-6DS, by Tokyo Denshoku Co., Ltd.). An amber filter was used as the filter used in the measurement.

Fogging defined as Dr-Ds, where Ds (%) is the worst value of reflectance in the white background portion and Dr (%) is the reflectance of the transfer material prior to image formation, was evaluated in accordance with the criteria below. The evaluation results are given in Table 4.

Evaluation Criteria

A: Fogging lower than 1.0%

B: Fogging from 1.0% to less than 3.0%

C: Fogging from 3.0% to less than 5.0%

D: Fogging 5.0% or higher

TABLE 4

| | | Low- | Heat- | Hot | | Durability |
|---|---|---|---|---|---|---|
| | | temperature | resistant | offset | | fogging % |
| | | fixability | storability | resistance | Stackability | after |
| | | ° C. | % | ° C. | % | 3000 prints |
| Example 1 | Toner 1 | A | A | A | A | A |
| | | 100 | 10 | 70 | 0.2 | 0.2 |
| Example 2 | Toner 2 | A | A | A | A | A |
| | | 100 | 10 | 70 | 0.2 | 0.2 |
| Example 3 | Toner 3 | C | A | A | A | A |
| | | 115 | 10 | 70 | 0.1 | 0.3 |
| Example 4 | Toner 4 | C | A | A | C | A |
| | | 115 | 10 | 70 | 1.5 | 0.3 |
| Example 5 | Toner 5 | A | A | B | C | B |
| | | 95 | 15 | 55 | 1.6 | 1.5 |
| Example 6 | Toner 6 | A | A | B | C | B |
| | | 95 | 15 | 55 | 1.7 | 1.5 |
| Example 7 | Toner 7 | C | B | A | C | A |
| | | 115 | 20 | 60 | 1.5 | 0.4 |
| Example 8 | Toner 8 | C | B | A | C | A |
| | | 120 | 22 | 60 | 1.7 | 0.4 |
| Example 9 | Toner 9 | A | A | B | B | B |
| | | 95 | 15 | 50 | 0.7 | 1.5 |
| Example 10 | Toner 10 | A | A | B | B | B |
| | | 95 | 15 | 55 | 0.7 | 1.5 |
| Example 11 | Toner 11 | A | C | B | C | B |
| | | 95 | 28 | 55 | 1.7 | 1.6 |
| Example 12 | Toner 12 | C | A | B | B | A |
| | | 115 | 15 | 55 | 0.7 | 0.5 |
| Example 13 | Toner 13 | C | A | B | B | A |
| | | 120 | 15 | 50 | 0.9 | 0.6 |
| Example 14 | Toner 14 | C | A | A | A | A |
| | | 115 | 12 | 60 | 0.2 | 0.4 |
| Example 15 | Toner 15 | C | A | A | A | A |
| | | 115 | 10 | 65 | 0.2 | 0.4 |
| Example 16 | Toner 16 | C | A | A | A | A |
| | | 120 | 8 | 65 | 0.3 | 0.4 |
| Example 17 | Toner 17 | C | A | A | A | A |
| | | 120 | 8 | 70 | 0.4 | 0.5 |
| Example 18 | Toner 18 | A | A | B | B | B |
| | | 100 | 15 | 55 | 0.6 | 1.5 |
| Example 19 | Toner 19 | A | A | B | B | B |
| | | 100 | 15 | 55 | 0.8 | 1.5 |
| Example 20 | Toner 20 | A | B | B | C | B |
| | | 100 | 20 | 50 | 1.6 | 1.6 |
| Example 21 | Toner 21 | B | A | A | A | A |
| | | 110 | 10 | 80 | 0.4 | 0.3 |
| Example 22 | Toner 22 | C | A | A | C | A |
| | | 120 | 10 | 80 | 1.8 | 0.4 |
| Example 23 | Toner 23 | A | B | C | C | C |
| | | 95 | 20 | 40 | 1.9 | 3.2 |
| C.E.1 | C.T.1 | D | B | B | D | B |
| | | 135 | 24 | 55 | 2.2 | 2.0 |
| C.E.2 | C.T.2 | A | D | C | D | C |
| | | 95 | 35 | 45 | 2.4 | 3.4 |
| C.E.3 | C.T.3 | D | A | B | C | 8 |
| | | 135 | 10 | 50 | 1.2 | 1.5 |
| C.E.4 | C.T.4 | D | A | A | A | A |
| | | 135 | 8 | 70 | 0.3 | 0.5 |
| C.E.5 | C.T.5 | A | C | D | D | C |
| | | 95 | 25 | 10 | 2.1 | 4.0 |
| C.E.6 | C.T.6 | D | A | C | D | A |
| | | 160 | 10 | 40 | 3.0 | 0.8 |
| C.E.7 | C.T.7 | D | A | B | A | A |
| | | 140 | 10 | 55 | 0.4 | 0.7 |
| C.E.8 | C.T.8 | A | B | D | D | C |
| | | 95 | 23 | 10 | 2.4 | 3.5 |
| C.E.9 | C.T.9 | A | B | D | D | C |
| | | 100 | 24 | 30 | 2.1 | 3.5 |

In the table, “C.F.” indicates “Comparative example”, “C.” indicates “Comparative”, and the numerical value of hot offset resistance denotes the numerical value of XX in “Fixing onset temperature+XX ° C.” in the evaluation criteria.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-100653, filed Jun. 22, 2022, which is hereby incorporated by reference herein in its entirety.

What is claimed is:

1. A toner comprising a toner particle, the toner particle comprising:
a binder resin,
wherein the binder resin comprises an amorphous resin A and a crystalline resin C;
T1, T2 and T3 satisfy expressions (1) and (2)
T3−T1<10.0 (1)
50.0<T2<70.0 (2)
wherein, in a viscoelasticity measurement of the toner, T1 (° C.) represents a temperature at which a storage elastic modulus G′ is 3.0×10⁷ Pa, T2 (° C.) represents temperature at which the storage elastic modulus G′ is 1.0×10⁷ Pa, and T3 (° C.) represents a temperature at which the storage elastic modulus G′ is 3.0×10⁶ Pa;
in the viscoelasticity measurement of the toner, a storage elastic modulus G′ (100) at 100° C. is 1.0×10⁴ to 1.0×10⁶ Pa; and
in an observation of a cross section of the toner using a scanning transmission electron microscope,
a matrix-domain structure having a matrix by the crystalline resin C and domains by the amorphous resin A is observed in the cross section,
an area ratio of the domains in the cross section of the toner is 45 to 95 area %, and
a number-basis average surface area of the domains in the cross section of the toner is 100 to 100,000 nm².

2. The toner according to claim 1, wherein the area ratio of the domains in the cross section is 60 to 90 area %.

3. The toner according to claim 1, wherein the average surface area of the domains is 100 to 10,000 nm².

4. The toner according to claim 1, wherein the crystalline resin C comprises a monomer unit (a) represented by Formula (3) below 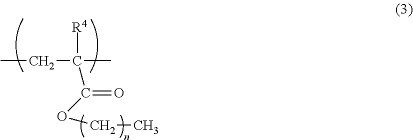
where, in Formula (3), R⁴ represents a hydrogen atom or a methyl group, and n represents an integer from 15 to 35.

5. The toner according to claim 4, wherein a content ratio of the monomer unit (a) represented by Formula (3) in the crystalline resin C is 50.0 to 100.0 mass %.

6. The toner according to claim 1, wherein a content ratio of the crystalline resin C in the toner is 10.0 to 60.0 mass %.

7. The toner according to claim 1, wherein the amorphous resin A comprises a monomer unit (b) represented by Formula (4) below 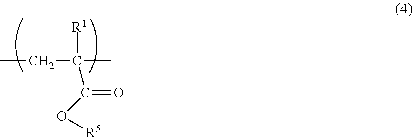
where, in Formula (4), R¹ represents a hydrogen atom or a methyl group, and R⁵ represents a C1 to C4 alkyl group.

8. The toner according to claim 7, wherein the R⁵ is a methyl group or a t-butyl group.

9. The toner according to claim 1, wherein the amorphous resin A comprises a monomer unit (c) represented by Formula (7) below 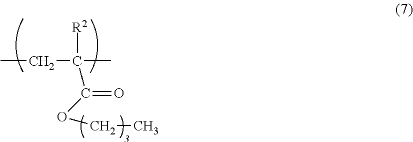
where, in Formula (7), R² represents a hydrogen atom or a methyl group, and m represents an integer from 7 to 35.

10. The toner according to claim 1,
wherein the crystalline resin C is a vinyl resin; and
the amorphous resin A is a vinyl resin.
